(19) United States
(12) Patent Application Publication
(10) Pub. No.: US 2016/0072571 A1
(43) Pub. Date: Mar. 10, 2016

(54) METHOD AND APPARATUS FOR BEAM-SPACE MULTI-INPUT MULTI-OUTPUT TRANSMISSION BASED LOAD-MODULATION

(71) Applicants: Electronics and Telecommunications Research Institute, Daejeon (KR); GAMMA NU, INC., Hwaseong-si Gyeonggi-do (KR)

(72) Inventors: Seung Eun HONG, Daejeon (KR); Kyoungsub OH, Hwaseong-si Gyeonggi-do (KR); Sang-jin KIM, Hwaseong-si Gyeonggi-do (KR); Duk Hyun YOU, Daejeon (KR); Il Gyu KIM, Okcheon-gun Chungcheongbuk-do (KR)

(21) Appl. No.: 14/846,223

(22) Filed: Sep. 4, 2015

(30) Foreign Application Priority Data
Sep. 4, 2014 (KR) 10-2014-0117928
Sep. 1, 2015 (KR) 10-2015-0123723

(51) Int. Cl. H04B 7/06; H04B 7/04

(52) U.S. Cl. CPC H04B 7/0697; H04B 7/0413; H04B 7/0617

(57) ABSTRACT

A method and an apparatus for beam-space multi-input multi-output (MIMO) transmission based load-modulation are disclosed. The apparatus for beam-space MIMO transmission includes: a plurality of impedance loading circuits each including a plurality of imaginary number impedance elements; a beam-space MIMO control unit calculating loading values of the plurality of imaginary number impedance elements in response to a spatial multiplexing signal; and an RF chain unit generating a first signal having a predetermined carrier frequency.

### CROSS-REFERENCE TO RELATED APPLICATION

This application claims priority to and the benefit of Korean Patent Application No. 10-2014-0117928, and No. 10-2015-0123723 filed in the Korean Intellectual Property Office on Sep. 4, 2014, and Sep. 1, 2015, respectively, the entire contents of which are incorporated herein by reference.

### BACKGROUND OF THE INVENTION

(a) Field of the Invention

The present invention relates to a method and an apparatus for beam-space multi-input multi-output transmission based on load-modulation.

(b) Description of the Related Art

In recent years, with the evolution of mobile smart apparatuses and services, the world has entered a hyper connection society and the big data age. As a result, mobile traffic has doubled every year and it is anticipated that the mobile traffic will increase by 1000 times or more in the next 10 years. Due to the rapid increase in mobile traffic, a burden of a mobile network provider has been aggravated.

In general, the capacity of a wireless network is determined through spectrum bandwidth, frequency efficiency, and cell density. In recent years, research into using millimeter waves has been in progress in order to secure a new frequency band, but it is anticipated that mass installation of small cells and enhancement of frequency efficiency will be more quickly realized. The need of a small base station further comes to the fore in order to easily install the small cell, and multi-input multi-output (MIMO) technology needs to be efficiently realized in terms of frequency efficiency. However, since multiple RF chains need to be installed at as many as there are antennas in a base station and a terminal in order to realize the MIMO, it is difficult to implement the MIMO in terms of economic cost and hardware. Further, a spatial limit is generated due to layout of the multiple antennas, and as a result, there is a limit in applying the MIMO technology to the small base station and the terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for beam-space MIMO transmission, which can maximize a compact antenna and frequency efficiency.

The present invention has also been made in an effort to provide a method and an apparatus for beam-space MIMO transmission, which minimizes complexity of an RF chain.

An exemplary embodiment of the present invention, a beam-space MIMO transmission apparatus is provided. The beam-space MIMO transmission apparatus including: a first impedance loading circuit connected to a first antenna element and including a plurality of first imaginary number impedance elements; a second impedance loading circuit connected to a second antenna element and including a plurality of second imaginary number impedance elements; a beam-space multi-input multi-output (MIMO) control unit receiving a spatial multiplexing signal for beam-space MIMO and calculating and setting loading values of the plurality of first and second imaginary number impedance elements in response to the spatial multiplexing signal; and a radio frequency (RF) chain unit generating a first signal having a predetermined carrier frequency and amplifying the first signal and transmitting the amplified first signal to the first and second impedance loading circuits

The first impedance loading circuit may include only the plurality of first imaginary number impedance elements, and the second impedance loading circuit may include only the plurality of second imaginary number impedance elements.

The first impedance loading circuit may include only the plurality of first imaginary number impedance elements and a first transmission line connected to the plurality of first imaginary number impedance elements; and the second impedance loading circuit may include only the plurality of second imaginary number impedance elements and only a second transmission line connected to the plurality of second imaginary number impedance elements

The beam-space MIMO control unit control unit may include: a beam-space mapping unit calculating current introduced into the first antenna element and the second antenna element by considering information on the spatial multiplexing signal; and a load modulator control unit calculating loading values of the plurality of respective antenna elements by using the calculated current.

The beam-space mapping unit may calculate the current by further considering information on basis beams orthogonal to each other and information on geometrical structures of the first and second antenna elements.

The first signal may be a sine wave having a fixed size and a fixed phase.

The RF chain unit may include: an oscillator generating the first signal; and a power amplifier amplifying the first signal.

The plurality of first imaginary number impedance elements may have a pi-type structure, and the plurality of second imaginary number impedance elements may have the pi-type structure.

The plurality of first imaginary number impedance elements may have a T-type structure, and the plurality of second imaginary number impedance elements may have the T-type structure.

According to another exemplary embodiment of the present invention, a beam-space multi-input multi-output (MIMO) transmission method generating a beam-space signal by modulating loads connected to a plurality of antenna elements is provided. The method includes: providing a plurality of imaginary number impedance elements to each of the plurality of antenna elements; generating a spatial multiplexing signal with respect to a plurality of data streams; calculating loading values of the plurality of imaginary number impedance elements in response to the spatial multiplexing signal; setting the calculated loading values in the plurality of imaginary number impedance elements; and generating a first signal having a predetermined carrier frequency and transmitting the generated first signal to the plurality of antenna elements and the plurality of imaginary number impedance elements.

The calculating of the loading values may includes: calculating current introduced into the plurality of antenna elements by using the spatial multiplexing signal; and calculating loading values of the plurality of imaginary number impedance elements by using the calculated current.

The first signal may be a sine wave having a fixed size and a fixed phase which do not vary according to the spatial multiplexing signal.

The load may be constituted by only the plurality of imaginary number impedance elements.

According to another exemplary embodiment of the present invention, A beam-space MIMO base station is provided. The base station includes: a compact antenna unit including a plurality of antenna elements; a plurality of impedance loading circuits including a plurality of imaginary number impedance elements connected to the plurality of antenna elements, respectively; a baseband unit generating a spatial multiplexing signal with respect to a plurality of data streams corresponding to the plurality of antenna elements; a beam-space MIMO control unit calculating loading values of the plurality of imaginary number impedance elements in response to the spatial multiplexing signal and setting the calculated loading values in a plurality of impedance loading circuits; and an RF chain unit generating a first signal having a predetermined carrier frequency and transmitting the generated first signal to the plurality of impedance loading circuits.

Each of the plurality of impedance loading circuits may be constituted by only the plurality of imaginary number impedance elements without a resistance component.

The beam-space MIMO control unit includes: a beam-space mapping unit calculating current introduced into each of the plurality of antenna elements by considering information on the spatial multiplexing signal, information on basis beams orthogonal to each other, and information on a geometrical structure of the compact antenna unit; and a load modulator control unit calculating the loading values of the plurality of imaginary number impedance elements by using the calculated current.

The first signal may be a sine wave having a fixed size and a fixed phase which do not vary according to the spatial multiplexing signal.

The plurality of imaginary number impedance elements may be have a pi-type structure or a T-type structure.

The plurality of antenna elements may be positioned at a distance that is smaller than a half-wavelength separation distance from each other.

According to an exemplary embodiment of the present invention, an antenna loading circuit is configured by only an imaginary number impedance element to perform beam-space MIMO transmission.

According to another exemplary embodiment of the present invention, a beam-space MIMO signal is generated based on load-modulation to simply configure a radio frequency (RF) chain unit.

### BRIEF DESCRIPTION OF THE DRAWINGS

FIG. 1 is a block diagram of a downlink of a load-modulation based beam-space MIMO base station according to an exemplary embodiment of the present invention.

FIG. 2 is a diagram illustrating, in detail, a beam-space MIMO transmission apparatus according to the exemplary embodiment of the present invention.

FIG. 3 is a diagram illustrating antenna circuit analysis when the number of antennas is 2.

FIG. 4 is a diagram illustrating the case where imaginary number impedance elements have a T-type structure.

FIG. 5 is a diagram illustrating a load modulation unit according to another exemplary embodiment of the present invention.

FIGS. 6A to 6C are diagrams illustrating various layouts of respective antenna elements.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may be designated as a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like, and may include all or some of the terminal, the MT, the AMS, the HR-MS, the SS, the PSS, the AT, the UE, and the like.

Further, the base station (BS) may designate an advanced base station (ABS), a node B, an evolved node B (eNB), a high reliability base station (HR-BS), an access point (AP), a radio access station (RAS), a base transceiver station (BTS), a mobile multihop relay (MMR)-BS, a relay station (RS) serving as a base station, a high reliability relay station (HR-RS) serving as the base station, and the like, and may include all or some functions of the ABS, the node B, the eNodeB, the AP, the RAS, the BTS, the MMR-BS, the RS, the HR-BS, and the like.

Exemplary embodiments of the present invention may be based on standard documents disclosed in at least one of the IEEE (Institute of Electrical and Electronics Engineers) 802 system, the 3GPP system, the 3GPP LTE system, and the 3GPP2 system. That is, steps or parts which are not described to definitely show the technical spirit of the present invention among the exemplary embodiments of the present invention may be based on the documents. Further, all terms disclosed in the document may be described by the standard document. Specific terms used in the following description are provided to help appreciating the present invention and the use of the specific terms may be modified into other forms within the scope without departing from the technical spirit of the present invention.

Hereinafter, a method and an apparatus for beam-space multi-input multi-output (MIMO) transmission based on load-modulation according to exemplary embodiments of the present invention will be described.

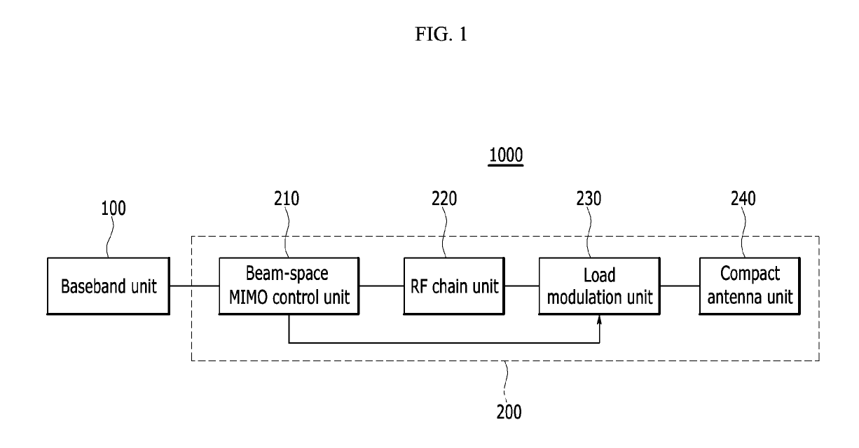

FIG. 1 is a block diagram of a downlink of a load-modulation based beam-space MIMO base station according to an exemplary embodiment of the present invention.

As illustrated in FIG. 1, the load-modulation-based beam-space MIMO base station 1000 according to the exemplary embodiment of the present invention includes a baseband unit 100 and a beam-space MIMO transmission apparatus 200.

The baseband unit 100 generates a spatial multiplexing signal through spatial precoding with respect to a plurality of data streams. Since a method in which the baseband unit 100 generates the spatial multiplexing signal for beam-space MIMO transmission can be known by those skilled in the art, a detailed description of the method will be omitted.

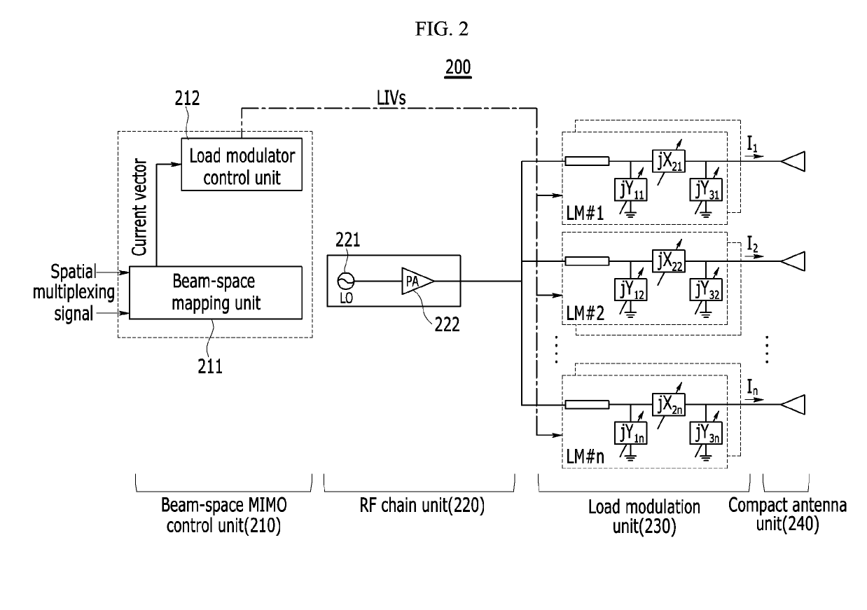

As illustrated in FIG. 1, a beam-space MIMO transmission apparatus 200 includes a beam-space MIMO control unit 210, an RF chain unit 220, a load modulation unit 230, and a compact antenna unit 240. A detailed configuration and operation of the beam-space MIMO transmission apparatus 200 will be described below in detail with reference to FIG. 2.

FIG. 2 is a diagram illustrating the beam-space MIMO transmission apparatus 200 according to the exemplary embodiment of the present invention in detail.

As illustrated in FIG. 2, the beam-space MIMO control unit 210 according to the exemplary embodiment of the present invention includes a beam-space mapping unit 211 and a load modulator control unit 212.

The beam-space mapping unit 211 receives the spatial multiplexing signal from the baseband unit 100 and maps the received spatial multiplexing signal onto a beam space.

The beam-space mapping unit 211 sets basis beams expressing the beam space based on a geometric structure of a used antenna. In addition, the beam-space mapping unit 211 determines a final beam pattern radiated to a radio space through linear coupling of the basis beams and signals to be spatially multiplexed. Herein, since an antenna steering vector is given, the final beam pattern is determined by a current that is introduced into antenna elements (that is, antennas of the compact antenna unit 240)

The current introduced into the antenna elements has a current vector form, and a current vector calculated by the beam-space mapping unit 211 is input into the load modulator control unit 212. A method in which the beam-space mapping unit 211 performs beam-space multiplexing mapping will be described below in more detail.

The load modulator control unit 212 receives the current vector introduced for each antenna element from the beam-space mapping unit 211 to calculate loaded impedance values (LIVs) for a beam-space MIMO operation. The loaded impedance values (LIVs) is related with an impedance loading circuit configuration of the load modulation unit 230. A method for calculating the loaded impedance values (LIVs) will be described below in detail. The load modulator control unit 212 outputs the calculated loaded impedance values (LIVs) to the load modulation unit 230.

Beam-Space Multiplexing Mapping

The beam-space mapping unit 211 performs the beam-space multiplexing mapping, and the beam-space multiplexing mapping method will be described hereinafter. The beam-space multiplexing mapping corresponds to calculating the current introduced for each antenna element.

In the case of a general MIMO transmission apparatus in which the RF chain exists for each antenna element, spatial multiplexing signal streams are transferred to the corresponding antenna element through individual RF chains. However, the beam-space MIMO transmission apparatus 200 adjusts orthogonal beam patterns in which spatial multiplexing signals are provided by the antenna. When the adjusted orthogonal beam patterns are expressed by a mathematical model, the adjusted orthogonal beam patterns are as shown in Equation 1 given below.

$$\begin{matrix}{P}_{T} ( θ , ϕ ) = {\sum }_{n = 0}^{M - 1} {S}_{bs , n} {Φ}_{n} ( θ , ϕ ) \\ = {\sum }_{n = 0}^{M - 1} {\sum }_{m = 0}^{M - 1} {i}_{m} {q}_{mn} {Φ}_{n} ( θ , ϕ ) \\ = {\sum }_{m = 0}^{M - 1} {i}_{m} {\sum }_{n = 0}^{M - 1} {q}_{mn} {Φ}_{n} ( θ , ϕ ) \\ = {\sum }_{m = 0}^{M - 1} {i}_{m} {a}_{m} ( θ , ϕ )\end{matrix} \qquad ( Equation 1 )$$

In Equation 1, P_{T}(θ,φ) expresses a radiation pattern to the radio space in 3 dimensions (3D), aₘ(θ,φ) expresses a steering vector of an m-th antenna element in 3D, and Φₙ(θ,φ) expresses an n-th basis beam pattern in 3D. qₘₙ expresses projection of the steering vector of the m-th antenna element on the n-th basis beam pattern, and iₘ expresses current introduced into the m-th antenna element. In addition, s_{bs,n} expresses a spatial multiplexing signal mapped to an n-th basis beam.

When information on the spatial multiplexing signal, information on the basis beam, and information on the steering vector projection of the antenna element are determined, the current introduced into the antenna element may be acquired through a first equation and a second equation of Equation 1. That is, the current introduced into the antenna element may be expressed as shown in Equation 2 given below.

s_{bs,n}=i^{T}qₙ,qₙ=[q₀ₙ . . . q_{(N-1)n}]^{T} (Equation 2)

In the case of a uniform linear array antenna, 2D expression of the steering vector is as shown in Equation 3 given below.

a(φ)=[1e^{-jb sin φ}e^{-j2b sin φ} . . . e^{-j(N-1)b sin φ}]^{T} (Equation 3)

In addition, in the case of a circular array antenna having an electronically steerable parasitic array radiator (ESPAR) shape, the 2D expression of the steering vector is as shown in Equation 4 given below.

a(φ)=[1e^{jb cos(φ-φ}^{₁}⁾e^{jb cos(φ-φ}^{₂}⁾ . . . e^{jb cos(φ-φ}^{_{N-1}}⁾]^{T} (Equation 4)

In Equations 3 and 4, b=2πd, d represents an interval of antenna elements normalized to a wavelength, and N represents the number of antenna elements. Further, φₘ is as shown in Equation 5 given below.

$${ϕ}_{m} = \frac{m - 1}{N - 1} ( 2 π ) , m = 1 , ⋯ , N - 1 \qquad ( Equation 5 )$$

A method for deriving the basis beams from the antenna steering vector includes various methods, and one example is a Gram-Schmidt orthogonalization process.

The Gram-Schmidt orthogonalization process is described below. A first function a₀(φ) is selected in the steering vector to determine a first basis beam pattern as shown in Equation 6 given below.

Φ₀(φ)=a₀(φ)/k₀ (Equation 6)

In Equation 6, k₀=\sqrt{∫₀^{2π}|a₀(φ)|²dφ}.

In a second basis beam pattern, q₁₀ which is projection onto Φ₀(φ) of a₁(φ) is calculated, and thereafter, q₁₀Φ₀(φ) is subtracted from a₁(φ), which is calculated while being divided by k1, in order to normalize the process. When the process is generalized, the basis beam pattern is shown as in Equation 7 given below.

$${Φ}_{n} ( ϕ ) = \frac{1}{{k}_{n}} ( {a}_{n} ( ϕ ) - {\sum }_{s = 0}^{n - 1} {q}_{ns} {Φ}_{s} ( ϕ ) ) ∀ n = 1 , ⋯ , M - 1 \\ {k}_{n} = {( {\int }_{0}^{2 π} {\vert {a}_{n} ( ϕ ) - {\sum }_{s = 0}^{n - 1} {q}_{n s} {Φ}_{s} ( ϕ ) \vert}^{2} d ϕ )}^{1 / 2} \\ {q}_{ns} = {\int }_{0}^{2 π} {a}_{n} ( ϕ ) {Φ}_{s}^{*} ( ϕ ) d ϕ \qquad ( Equation 7 )$$

In the following description, the beam-space multiplexing mapping method for constitution by two antenna elements is described for easy description, but it is natural that the constitution may be extended to N antenna elements. The steering vector for two element antennas is determined as shown in Equation 8 given below.

a(φ)=[1e^{jb cos(φ)}]^{T} (Equation 8)

The basis beam patterns for two antenna elements are determined as shown in Equation 9 given below through the steering vector of Equation 8 and the Gram-Schmidt orthogonalization process.

$${Φ}_{0} ( ϕ ) = 1 / {k}_{0} , {k}_{0} = \sqrt{2 π} \\ {q}_{10} = \frac{1}{{k}_{0}} {\int }_{0}^{2 π} {e}^{jb cos ϕ} d ϕ = 2 π {I}_{0} ( jb ) / {k}_{0} \\ Φ ( ϕ ) = \frac{1}{{k}_{1}} ( {e}^{jb cos ϕ} - 2 π {I}_{0} ( jb ) / {k}_{0}^{2} ) \\ \begin{matrix}{k}_{1} = \sqrt{{\int }_{0}^{2 π} {\vert {e}^{jb cos ϕ} - 2 π {I}_{0} ( jb ) / {k}_{0}^{2} \vert}^{2} d ϕ} \\ = \sqrt{{\int }_{0}^{2 π} {[ cos ( b cos ϕ ) - 2 {πI}_{0} ( jb ) / {k}_{0}^{2} ]}^{2} d ϕ + {\int }_{0}^{2 π} {sin}^{2} ( b cos ϕ ) d ϕ} \\ = \sqrt{2 π + ( π / {k}_{0}^{2} - 1 ) 8 {π}^{2} {I}_{0}^{2} ( jb ) / {k}_{0}^{2}}\end{matrix} \qquad ( Equation 9 )$$

Through Equation 2 and Equation 9, the relation equation between a signal multiplexed to the beam space and current is established as shown in Equation 10 given below.

$$[ \begin{matrix}{s}_{bs , 0} & {s}_{bs , 1}\end{matrix} ] = [ \begin{matrix}{i}_{0} & {i}_{1}\end{matrix} ] [ \begin{matrix}{q}_{00} & {q}_{01} \\ {q}_{10} & {q}_{11}\end{matrix} ] = [ \begin{matrix}{i}_{0} & {i}_{1}\end{matrix} ] [ \begin{matrix}{k}_{0} & 0 \\ 2 π {I}_{0} ( j b ) / {k}_{0} & {k}_{1}\end{matrix} ] \qquad ( Equation 10 )$$

Calculation of Loaded Impedance Values

Next, a method in which the load modulator control unit 212 calculates the loaded impedance values (LIVs) for the beam-space MIMO operation will be described.

As illustrated in FIG. 2, in the load modulation unit 230, each of impedance loading circuits LM#1 to LM#n is constituted by three imaginary number impedance elements and a transmission line for each antenna. FIG. 2 illustrates only the case in which the imaginary number impedance elements are connected as a pi-type, but the imaginary number impedance elements may be connected as a T-type. Hereinafter, for easy description, when the impedance loading circuit is constituted by the transmission line and the pi-type imaginary number impedances, a procedure and a method for calculating an imaginary number impedance element value will be described. It is assumed that the number of antennas is 2 for easy calculation, but the number of antennas may be extended to n as described below.

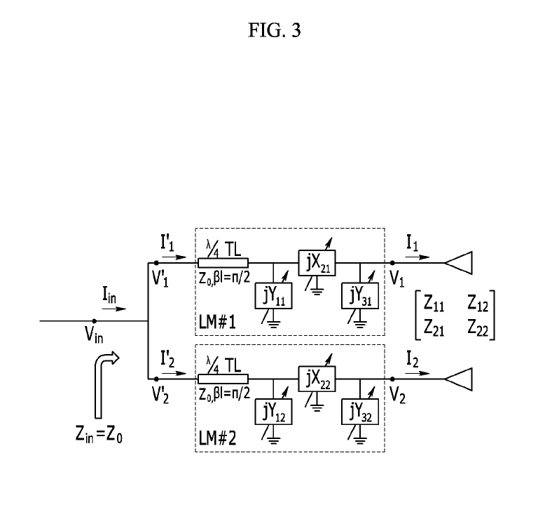

FIG. 3 is a diagram illustrating antenna circuit analysis when the number of antennas is 2.

When the antenna configuration illustrated in FIG. 3 is analyzed by a Z parameter, the antenna configuration may be expressed as shown in Equation 11 given below.

$$[ \begin{matrix}{V}_{1} \\ {V}_{2}\end{matrix} ] = [ \begin{matrix}{Z}_{11} & {Z}_{12} \\ {Z}_{21} & {Z}_{22}\end{matrix} ] [ \begin{matrix}{I}_{1} \\ {I}_{2}\end{matrix} ] = [ \begin{matrix}{Z}_{0} ( {z}_{11 , r} + j {z}_{11 , i} ) & {Z}_{0} ( {z}_{12 , r} + j {z}_{12 , i} ) \\ {Z}_{0} ( {z}_{21 , r} + j {z}_{21 , i} ) & {Z}_{0} ( {z}_{22 , r} + j {z}_{22 , i} )\end{matrix} ] [ \begin{matrix}{I}_{1} \\ {I}_{2}\end{matrix} ] \qquad ( Equation 11 )$$

I₁ and I₂ of Equation 11 correspond to i₀ and i₁ of Equation 10, respectively.

Analysis of the impedance loading circuit LM#1 and LM#2 is required for each antenna of the load modulation unit 230. Other parameters (Z, Y, or S parameter) may also be used, but when circuit networks having two or more ports are connected in series, respective circuit network ABCC parameter matrixes are multiplied to easily acquire all ABCD parameters. Accordingly, for easy circuit analysis, hereinafter, the circuit analysis will be described by using the ABCD parameters.

A characteristic impedance value Z₀ of the transmissions line is impedance when the length of the line is infinite and the ABCD parameters of the transmission line having a length of l are shown in Equation 12 given below through the characteristic impedance value.

$$[ \begin{matrix}cos β l & j {Z}_{0} sin β l \\ j \frac{1}{{Z}_{0}} sin β l & cos β l\end{matrix} ] \qquad ( Equation 12 )$$

In Equation 12, β as a wave number has a value of 2π/λ. Accordingly, in the case of a quarter-wavelength transmission line (that is, l=λ/4), the ABCD parameters are shown in Equation 13 given below.

$$[ \begin{matrix}0 & j {Z}_{0} \\ j \frac{1}{{Z}_{0}} & 0\end{matrix} ] \qquad ( Equation 13 )$$

The ABCD parameters for the impedance loading circuit LM#1 may be determined as shown in Equation 14 given below.

$$\begin{matrix}[ \begin{matrix}{V}_{1}^{′} \\ {I}_{1}^{′}\end{matrix} ] = [ \begin{matrix}{A}_{1} & {B}_{1} \\ {C}_{1} & {D}_{1}\end{matrix} ] [ \begin{matrix}{V}_{1} \\ {I}_{1}\end{matrix} ] \\ = [ \begin{matrix}0 & j {Z}_{0} \\ j \frac{1}{{Z}_{0}} & 0\end{matrix} ] [ \begin{matrix}1 & 0 \\ j {Y}_{11} & 1\end{matrix} ] [ \begin{matrix}1 & j {X}_{21} \\ 0 & 1\end{matrix} ] [ \begin{matrix}1 & 0 \\ j {Y}_{31} & 1\end{matrix} ] [ \begin{matrix}{V}_{1} \\ {I}_{1}\end{matrix} ] \\ = [ \begin{matrix}- {y}_{11} - {y}_{31} ( 1 - {x}_{21} {y}_{11} ) & j {Z}_{0} ( 1 - {x}_{21} {y}_{11} ) \\ j \frac{1}{{Z}_{0}} ( 1 - {x}_{21} {y}_{31} ) & - {x}_{21}\end{matrix} ] [ \begin{matrix}{V}_{1} \\ {I}_{1}\end{matrix} ] \\ = [ \begin{matrix}{a}_{1} & j {Z}_{0} {b}_{1} \\ j \frac{1}{{Z}_{0}} {c}_{1} & {d}_{1}\end{matrix} ] [ \begin{matrix}{V}_{1} \\ {I}_{1}\end{matrix} ]\end{matrix} \qquad ( Equation 14 )$$

In Equation 14, y₁₁, x₂₁, y₃₁ and a₁, b₁, c₁, d₁ are defined as shown in Equation 15 given below.

y₁₁=Z₀Y₁₁,x₂₁=X₂₁/Z₀,y₃₁=Z₀Y₃₁

a₁=−y₁₁−y₃₁(1−x₂₁,y₁₁),b₁=(1−x₂₁y₁₁),c₁=(1−x₂₁y₃₁),d₁=−x₂₁ (Equation 15)

From Equation 14, with respect to the impedance loading circuit LM#1, Equation 16 given below may be acquired.

$${V}_{1}^{′} = {a}_{1} {V}_{1} + j {Z}_{0} {b}_{1} {I}_{1} \\ {I}_{1}^{′} = j \frac{1}{{Z}_{0}} {c}_{1} {V}_{1} + {d}_{1} {I}_{1} \qquad ( Equation 16 )$$

In addition, a₁, b₁, c₁, d₁ have a relation equation shown in Equation 17 given below.

$${d}_{1} = \frac{1 - {b}_{1} {c}_{1}}{{a}_{1}} \qquad ( Equation 17 )$$

In the same manner, a relation equation shown in Equation 18 given below may be acquired with respect to the impedance loading circuit LM#2.

$${V}_{2}^{′} = {a}_{2} {V}_{2} + j {Z}_{0} {b}_{2} {I}_{2} \\ {I}_{2}^{′} = j \frac{1}{{Z}_{0}} {c}_{2} {V}_{2} + {d}_{2} {I}_{2} \qquad ( Equation 18 )$$

In addition, a₂, b₂, c₂, and d₂ have a relation equation shown in Equation 19 given below.

$${d}_{2} = \frac{1 - {b}_{2} {c}_{2}}{{a}_{2}} \qquad ( Equation 19 )$$

When a Kirchhoff's voltage/current law is applied at an input terminal of FIG. 3, Equation 20 given below is derived.

$${V}_{i n} = {V}_{1}^{′} = {a}_{1} {V}_{1} + j {Z}_{0} {b}_{1} {I}_{1} \\ {V}_{i n} = {V}_{2}^{′} = {a}_{2} {V}_{2} + j {Z}_{0} {b}_{2} {I}_{2} \\ {I}_{i n} = {I}_{1}^{′} + {I}_{2}^{′} = j \frac{1}{{Z}_{0}} {c}_{1} {V}_{1} + j \frac{1}{{Z}_{0}} {c}_{2} {V}_{2} + {d}_{1} {I}_{1} + {d}_{2} {I}_{2} \qquad ( Equation 20 )$$

Accordingly, input impedance Zᵢₙ may be arranged as shown in Equation 21 given below through Equation 20.

$${Z}_{i n} = \frac{{V}_{i n}}{{I}_{i n}} = \frac{{a}_{1} {V}_{1} + j {Z}_{0} {b}_{1} {I}_{1}}{j \frac{1}{{Z}_{0}} {c}_{1} {V}_{1} + j \frac{1}{{Z}_{0}} {c}_{2} {V}_{2} + {d}_{1} {I}_{1} + {d}_{2} {I}_{2}} \qquad ( Equation 21 )$$

Equations 20 and 21 may be arranged with I₁ as shown in Equation 22 given below by using the relation equation η=I₂/I₁=ηᵣ+jηᵢ and Equation 11.

Vᵢₙ=V′₁=Z₀[β₁₋a₁+j(δ₁₊a₁+b₁)]I₁

Vᵢₙ=V′₁=Z₀[(δ₂₋a₂−ηᵢb₂)+j(δ₂₊a₂+ηᵣb₂)]I₁

Iᵢₙ=[(d₁+ηᵣd₂−δ₁₊c₁−δ₂₊c₂)+j(ηᵢd₂+δ₂₋c₂)]I₁ (Equation 22)

In Equation 22, δ₁₋, δ₁₊, δ₂₋, δ₂₊ are defined as shown in Equation 23 below.

δ₁₋=z_{11,r}+ηᵣz_{12,r}−ηᵢz_{12,i},δ₁₊=z_{11,i}+ηᵣz_{12,i}+ηᵢz_{12,r}

δ₂₋=z_{21,r}+ηᵣz_{22,r}−ηᵢz_{22,i},δ₂₊=z_{21,i}+ηᵣz_{22,i}+ηᵢz_{22,r} (Equation 23)

Since Vᵢₙ=V′₁=V′₂, a relation equation such as Equation 24 given below may be derived from Equation 22.

δ₁₋a₁−δ₂₋a₂=−ηᵢb₂

δ₁₊a₁−δ₂₊a₂=ηᵣb₂−b₁ (Equation 24)

Further, when the relation equation Δ₁₂=δ₁₊δ₂₋−δ₁₋δ₂₊, Ω₂₁=ηᵣδ₁₋+ηᵢδ₁₊, δ₂₂=ηᵣδ₂₋+ηᵢδ₂₊ is used, a relation equation such as Equation 24a may be derived.

$${a}_{2} = \frac{{Ω}_{21} {b}_{2} - {δ}_{1 -} {b}_{1}}{{Δ}_{12}} , {a}_{1} = \frac{{Ω}_{22} {b}_{2} - {δ}_{2 -} {b}_{1}}{{Δ}_{12}} \qquad ( Equation 24 a )$$

In order to match the input impedance, the input impedance of Equation 21 given above needs to satisfy Equation 25 given below.

$${Z}_{i n} = \frac{{V}_{i n}}{{I}_{i n}} = \frac{{Z}_{0} [ {δ}_{1 -} {a}_{1} + j ( {δ}_{1 +} {a}_{1} + {b}_{1} ) ] {I}_{1}}{[ \begin{matrix}( {d}_{1} + {η}_{r} {d}_{2} - {δ}_{1 +} {c}_{1} - {δ}_{2 +} {c}_{2} ) + \\ j ( {η}_{i} {d}_{2} + {δ}_{1 -} {c}_{1} + {δ}_{2 -} {c}_{2} )\end{matrix} ] {I}_{1}} = {Z}_{0} \qquad ( Equation 25 )$$

Equation 26 given below is established from Equation 25 given above.

$${δ}_{1 -} {a}_{1} + j ( {δ}_{1 +} {a}_{1} + {b}_{1} ) = ( {d}_{1} + {η}_{r} {d}_{2} - {δ}_{1 +} {c}_{1} - {δ}_{2 +} {c}_{2} ) + j ( {η}_{i} {d}_{2} + {δ}_{1 -} {c}_{1} + {δ}_{2 -} {c}_{2} ) \\ ⇒ \{ \begin{matrix}{δ}_{1 -} {a}_{1} = {d}_{1} + {η}_{1} {d}_{2} - {δ}_{1 +} {c}_{1} - {δ}_{2 +} {c}_{2} \\ {δ}_{1 +} {a}_{1} + {b}_{1} = {η}_{i} {d}_{2} + {δ}_{1 -} {c}_{1} + {δ}_{2 -} {c}_{2}\end{matrix} \qquad ( Equation 26 )$$

When Equations 17 and 19 are substituted into Equation 26 given above, which is arranged by c₁ and c₂, Equation 27 given below is satisfied.

$$( {δ}_{1 +} + \frac{{b}_{1}}{{a}_{1}} ) {c}_{1} + ( {δ}_{2 +} + {η}_{r} \frac{{b}_{2}}{{a}_{2}} ) {c}_{2} = \frac{1}{{a}_{1}} + {η}_{r} \frac{1}{{a}_{2}} - {δ}_{1 -} {a}_{1} \\ {δ}_{1 -} {c}_{1} + ( {δ}_{2 -} - {η}_{i} \frac{{b}_{2}}{{a}_{2}} ) {c}_{2} = {δ}_{1 +} {a}_{1} + {b}_{1} - {η}_{i} \frac{1}{{a}_{2}} \qquad ( Equation 27 )$$

Since dual linear equations of c₁ and c₂ expressed by Equation 27 given above need to be the same, an equation such as Equation 28 given below needs to be satisfied.

$$\frac{{δ}_{1 +} + \frac{{b}_{1}}{{a}_{1}}}{{δ}_{1 -}} = \frac{{δ}_{2 +} + {η}_{r} \frac{{b}_{2}}{{a}_{2}}}{{δ}_{2 -} - {η}_{i} \frac{{b}_{2}}{{a}_{2}}} = \frac{\frac{1}{{a}_{1}} + {η}_{r} \frac{1}{{a}_{2}} - {δ}_{1 -} {a}_{1}}{{δ}_{1 +} {a}_{1} + {b}_{1} - {η}_{i} \frac{1}{{a}_{2}}} \qquad ( Equation 28 )$$

When it is used such that a first item and a third item are the same in Equation 28, an equation such as Equation 29 given below may be derived.

$${δ}_{1 -} ( \frac{1}{{a}_{1}} + {η}_{r} \frac{1}{{a}_{2}} - {δ}_{1 -} {a}_{1} ) = ( {δ}_{1 +} + \frac{{b}_{1}}{{a}_{1}} ) ( {δ}_{1 +} {a}_{1} + {b}_{1} - {η}_{i} \frac{1}{{a}_{2}} ) \qquad ( Equation 29 )$$

By using Equation 24a, when a1 and a2 are substituted into Equation 29, a quadratic equation such as Equation 30 given below may be derived.

(δ₁₊²+δ₁₋²)Ω₂₂²b₂²−2δ₁₋(δ₁₊δ₂₊+δ₁₋δ₂₋)Ω₂₂b₁b₂+δ₁₋²(δ₂₊²+δ₂₋²)b₁²−Δ₁₂²(β₁₋+Ω₂₂)=0 (Equation 30)

A solution of Equation 30 as a solution of the quadratic equation is determined as shown in Equation 31 given below by a function of b₁.

$$( Equation 31 )$$

$$\begin{matrix}{b}_{2} = {b}_{1} \frac{{δ}_{1 -} ( {δ}_{1 +} {δ}_{2 +} + {δ}_{1 -} {δ}_{2 -} )}{( {δ}_{1 +}^{2} + {δ}_{1 -}^{2} ) {Ω}_{22}} \\ ( 1 \pm \sqrt{1 + \frac{( {δ}_{1 +}^{2} + {δ}_{1 -}^{2} )}{{( {δ}_{1 +} {δ}_{2 +} + {δ}_{1 -} {δ}_{2 -} )}^{2}} [ \frac{{Δ}_{12}^{2} ( {δ}_{1 -} + {Ω}_{22} )}{{δ}_{1 -}^{2} {b}_{1}^{2}} - ( {δ}_{2 +}^{2} + {δ}_{2 -}^{2} ) ]} ) \\ = {b}_{1} \frac{{δ}_{1 -} ( {δ}_{1 -} {δ}_{2 -} + {δ}_{1 +} {δ}_{2 +} )}{( {δ}_{1 +}^{2} + {δ}_{1 -}^{2} ) {Ω}_{22}} \\ 〈 1 \pm \vert \frac{{Δ}_{12}}{{δ}_{1 +} {δ}_{2 +} + {δ}_{1 -} {δ}_{2 -}} \vert \sqrt{\frac{( {δ}_{1 +}^{2} + {δ}_{1 -}^{2} )}{{δ}_{1 -}^{2} {b}_{1}^{2}} ( {δ}_{1 -} + {Ω}_{22} ) - 1} 〉\end{matrix}$$

In Equation 31, when a value of b₁ is set to a predetermined value, b₂ is determined and a₁ and a₂ are determined through Equation 24.

Meanwhile, c₁ may be expressed as a function of c₂ as shown in Equation 32 given below from a second equation of Equation 27.

$${c}_{1} = \frac{{δ}_{1 +} {a}_{1} + {b}_{1} - {η}_{i} \frac{1}{{a}_{2}} - ( {δ}_{2 -} - {η}_{i} \frac{{b}_{2}}{{a}_{2}} ) {c}_{2}}{{δ}_{1 -}} \qquad ( Equation 32 )$$

In Equation 32, when c₂ is set to one predetermined value, c₁ is determined and d₁ and d₂ may be acquired from Equations 17 and 19.

Accordingly, load values may be determined as shown in Equation 33 given below from Equation 15.

$${x}_{21} = - {d}_{1} , {y}_{11} = \frac{{b}_{1} - 1}{{d}_{1}} , \\ {y}_{31} = - \frac{{b}_{1} - 1}{{b}_{1} {d}_{1}} - \frac{{a}_{1}}{{b}_{1}} = \frac{{c}_{1} - 1}{{d}_{1}} \\ {x}_{22} = - {d}_{2} , {y}_{11} = \frac{{b}_{2} - 1}{{d}_{2}} , \\ {y}_{32} = - \frac{{b}_{2} - 1}{{b}_{2} {d}_{2}} - \frac{{a}_{2}}{{b}_{2}} = \frac{{c}_{2} - 1}{{d}_{2}} \qquad ( Equation 33 )$$

Herein, a matter to be considered is a phase component of the current. A current phase may be expressed as shown in Equation 34 given below from Equation 22.

$$\begin{matrix}∠ \frac{{I}_{1}}{{I}_{i n}} = {tan}^{- 1} ( \frac{- {η}_{i} {d}_{2} - {δ}_{1 -} {c}_{1} - {δ}_{2 -} {c}_{2}}{{d}_{1} + {η}_{r} {d}_{2} - {δ}_{1 +} {c}_{1} - {δ}_{2 +} {c}_{2}} ) \\ = ∠ \frac{{Z}_{0} {I}_{1}}{{V}_{i n}} \\ = ∠ \frac{{I}_{1}}{{V}_{i n}} \\ = {tan}^{- 1} ( \frac{- {δ}_{1 +} {a}_{1} - {b}_{1}}{{δ}_{1 -} {a}_{1}} ) \\ = θ\end{matrix} \qquad ( Equation 34 )$$

The phase component of the current needs to be fixed so as to not be changed according to changed load values. That is, in Equation 34, θ needs to be fixed. Therefore, Equation 35 given below is established.

$$\begin{matrix}{tan}^{- 1} ( \frac{- {δ}_{1 +} {a}_{1} - {b}_{1}}{{δ}_{1 -} {a}_{1}} ) = θ ⇔ - {b}_{1} \\ = {a}_{1} ( {δ}_{1 +} + {δ}_{1 -} tan θ )\end{matrix} \qquad ( Equation 35 )$$

In Equation 35, when a1 is substituted with Equation 24, Equation 36 given below is established.

Ω₂₂(δ₁₊+δ₁₋tan θ)b₂=δ₁₋(δ₂₊+δ₂₋tan θ)b₁ (Equation 36)

When Equation 35 is arranged together with Equation 31, Equation 36a which is a b₁ equation may be derived.

$$\begin{matrix}{b}_{1}^{2} = \frac{{( {δ}_{1 +} + {δ}_{1 -} tan θ )}^{2} ( {δ}_{1 -} + {Ω}_{22} )}{{δ}_{1 -}^{2} ( 1 + {tan}^{2} θ )} ⇒ {b}_{1} \\ = \pm \frac{{δ}_{1 +} + {δ}_{1 -} tan θ}{{δ}_{1 -} \sqrt{1 + {tan}^{2} θ}} \sqrt{{δ}_{1 -} + {Ω}_{22}}\end{matrix} \qquad ( Equation 36 a )$$

Accordingly, parameters b₂, a₂, and a₁ may be determined as shown in Equation 37 given below.

$${b}_{2} = \pm \frac{{δ}_{2 +} + {δ}_{2 -} tan θ}{{Ω}_{22} \sqrt{1 + {tan}^{2} θ}} \sqrt{{δ}_{1 -} + {Ω}_{22}} \\ {a}_{2} = ∓ \frac{{η}_{r} - {η}_{i} tan θ}{{Ω}_{22} \sqrt{1 + {tan}^{2} θ}} \sqrt{{δ}_{1 -} + {Ω}_{22}} \\ {a}_{1} = ∓ \frac{1}{{δ}_{1 -} \sqrt{1 + {tan}^{2} θ}} \sqrt{{δ}_{1 -} + {Ω}_{22}} \qquad ( Equation 37 )$$

When Equations 36a and 37 are substituted into Equation 32, Equation 38 given below may be derived.

$${δ}_{1 -} {c}_{1} + \frac{{Ω}_{22}}{{η}_{r} - {n}_{i} tan θ} {c}_{2} ∓ {η}_{i} \frac{{Ω}_{22}}{{η}_{r} - {n}_{i} tan θ} \frac{\sqrt{1 + {tan}^{2} θ}}{\sqrt{{δ}_{1 -} + {Ω}_{22}}} = \pm tan θ \frac{\sqrt{{δ}_{1 -} + {Ω}_{22}}}{\sqrt{1 + {tan}^{2} θ}} ⇔ {δ}_{1 -} ( {c}_{1} ∓ \frac{tan θ}{\sqrt{1 + {tan}^{2} θ} \sqrt{{δ}_{1 -} + {Ω}_{22}}} ) + \frac{{Ω}_{22}}{{η}_{r} - {n}_{i} tan θ} ( {c}_{2} ∓ \frac{{η}_{i} + {η}_{r} tan θ}{\sqrt{1 + {tan}^{2} θ} \sqrt{{δ}_{1 -} + {Ω}_{22}}} ) = 0 \qquad ( Equation 38 )$$

Meanwhile, Equation 38 satisfies Equation 39 given below with respect to a predetermined s.

$$\frac{{Ω}_{22}}{{η}_{r} - {n}_{i} tan θ} ( {c}_{2} ∓ \frac{{η}_{i} + {η}_{r} tan θ}{\sqrt{1 + {tan}^{2} θ} \sqrt{{δ}_{1 -} + {Ω}_{22}}} ) = s \\ {δ}_{1 -} ( {c}_{1} ∓ \frac{tan θ}{\sqrt{1 + {tan}^{2} θ} \sqrt{{δ}_{1 -} + {Ω}_{22}}} ) = - s \qquad ( Equation 39 )$$

Accordingly, values of c₁ and c₂ to be acquired may be calculated as shown in Equation 40 given below with respect to the predetermined s.

$${c}_{1} = - \frac{1}{{δ}_{1 -}} s \pm \frac{tan θ}{\sqrt{1 + {tan}^{2} θ} \sqrt{{δ}_{1 -} + {Ω}_{22}}} \\ {c}_{2} = \frac{{η}_{r} - {n}_{i} tan θ}{{Ω}_{22}} s \pm \frac{{η}_{i} + {η}_{r} tan θ}{\sqrt{1 + {tan}^{2} θ} \sqrt{{δ}_{1 -} + {Ω}_{22}}} \qquad ( Equation 40 )$$

Meanwhile, θ may be fixed to a predetermined value, but since the loaded impedance value is determined according to a value of θ as described above, θ may be derived so that a variation of the calculated loaded impedance values is small.

When a fixed phase value is θ=0 and ±π, parameters a₁, b₁, c₁, a₂, b₂, and c₂ may be acquired as shown in Equation 41 given below through Equations 36, 37, and 40.

$${b}_{1} = \pm \frac{{δ}_{1 +}}{{δ}_{1 -}} \sqrt{{δ}_{1 -} + {Ω}_{22}} , \\ {b}_{2} = \frac{\pm {δ}_{2 +}}{{Ω}_{22}} \sqrt{{δ}_{1 -} + {Ω}_{22}} , \\ {a}_{2} = ∓ \frac{η}{{Ω}_{22}} \sqrt{{δ}_{1 -} + {Ω}_{22}} , \\ {a}_{1} = ∓ \frac{1}{{δ}_{1 -}} \sqrt{{δ}_{1 -} + {Ω}_{22}} \\ {c}_{1} = - \frac{1}{{δ}_{1 -}} s , {c}_{2} = \frac{{η}_{r}}{{Ω}_{22}} s \pm \frac{{η}_{i}}{\sqrt{{δ}_{1 -} + {Ω}_{22}}} \qquad ( Equation 41 )$$

When parameters a₁, b₁, c₁, a₂, b₂, and c₂ calculated as shown in Equation 41 are applied to Equations 17 and 19, the parameters d₁ and d₂ may be acquired. When all the parameters a₁, b₁, c₁, d₁ a₂, b₂, c₂, and d₂ calculated as described above are applied to Equation 15, the loaded impedance value may be finally acquired.

Meanwhile, as described above, in the case of calculation of the loaded impedance, which does not consider fixed phase, design parameter become b₁ and c₂. With respect to all sets of signal pairs that intend to perform the beam-space MIMO transmission, two design parameter values may be set so that antenna efficiency (e.g., antenna reflection coefficients depending on the loaded impedance calculation values) is high and the variation of the loaded impedance values is small. In this case, since a phase of current introduced into the antennas varies, a conversion for fixing a phase of current that flows from the beam-space MIMO control unit 210 to the RF chain unit 220 is required.

In addition, in the case of calculation of the loaded impedance, which considers the phase, as the design parameters, the fixed phase values θ and s (used to determine the value of c₁ and c₂) exist. With respect to all sets of signal pairs that intend to perform the beam-space MIMO transmission, two design parameter values may also be set so that antenna efficiency (e.g., the antenna reflection coefficients depending on the loaded impedance calculation values) is high and the variation of the loaded impedance values is small.

As described above, according to the exemplary embodiment of the present invention, the beam-space MIMO transmission may be implemented by only the imaginary number impedance element (reactance element). In the existing methods, when a QAM signal is transmitted, a negative impedance element is required or a long time is required to calculate the current introduced for each antenna element. The negative impedance element may be implemented through an active element (e.g., a power amp), and there is a problem in that the negative impedance element oscillates. Contrary to this, according to the exemplary embodiment of the present invention, the beam-space MIMO transmission may be implemented by only the imaginary number impedance element as described above.

Next, the RF chain unit 220 of FIG. 2 will be described.

As illustrated in FIG. 2, the RF chain unit 220 according to the exemplary embodiment of the present invention is constituted by a single RF chain. In addition, the RF chain unit 220 is constituted by only some elements among elements constituting a general RF chain.

The general RF chain is constituted by a digital analog converter (DAC) element converting a digital signal into an analog signal, a power amplifier (PA) element, a local oscillator generating a specific carrier frequency signal, and a mixer mixing a carrier frequency and an output signal of the DAC element.

However, as illustrated in FIG. 2, the RF chain unit 220 according to the exemplary embodiment of the present invention includes an oscillator 221 and a power amplifier 222. That is, in the load-modulation based beam-space MIMO transmission method according to the exemplary embodiment of the present invention, since a transmission signal need not be directly mixed at an RF terminal, the DAC element and the mixer are not required. The oscillator 221 has a predetermined carrier frequency and generates a sine wave having a size and a phase which are fixed. The power amplifier 222 constantly amplifies power of the transmission signal.

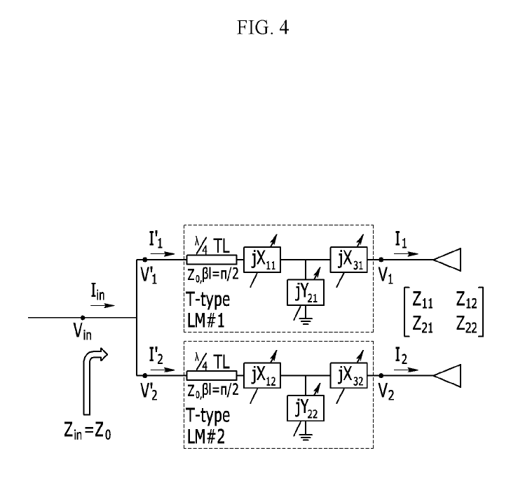

As illustrated in FIGS. 2 and 3, the load modulation unit 230 according to the exemplary embodiment of the present invention includes the plurality of impedance loading circuits LM#1 to LM#N. Each of the impedance loading circuits LM#1 to LM#N includes three imaginary number impedance elements and the transmission line. Meanwhile, as illustrated in FIGS. 2 and 3, the imaginary number impedance elements may have the pi(π)-type structure and as illustrated in FIG. 4, the imaginary number impedance elements may have the T-type structure. FIG. 4 is a diagram illustrating the case where imaginary number impedance elements have a T-type structure. That is, FIG. 4 is the same as FIG. 3 except that the imaginary number impedance elements have the T-type structure.

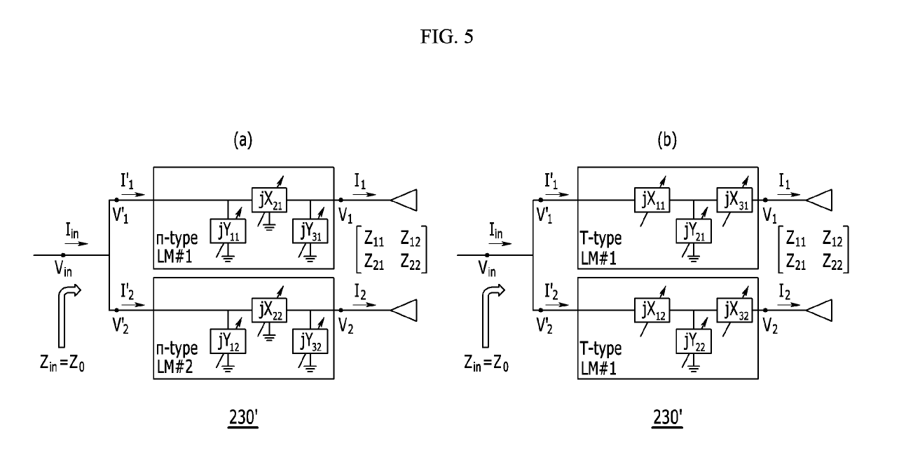

FIG. 5 is a diagram illustrating a load modulation unit 230′ according to another exemplary embodiment of the present invention. FIG. 5 (a) illustrates the case where each impedance loading circuit of the load modulation unit 230′ has the pi-type without the transmission line, and FIG. 5 (b) illustrates the case where each impedance loading circuit of the load modulation unit 230′ has the T-type structure without the transmission line. That is, FIG. 5 illustrates the case where the transmission line is omitted in FIGS. 2 to 4.

The impedance loading circuits of FIGS. 3, 4, and 5 are expressed by ABCD parameters shown in Equation 42 given below with respect to a specific single antenna.

$$[ \begin{matrix}{V}_{1}^{′} \\ {I}_{1}^{′}\end{matrix} ] = [ \begin{matrix}{a}_{1} & j {Z}_{0} {b}_{1} \\ j \frac{1}{{Z}_{0}} {c}_{1} & {d}_{1}\end{matrix} ] [ \begin{matrix}{V}_{1} \\ {I}_{1}\end{matrix} ] \qquad ( Equation 42 )$$

In Equation 42, a₁, b₁, c₁, and d₁ may be generalized to aᵢ, bᵢ, cᵢ, and dᵢ. aᵢ, bᵢ, cᵢ, and dᵢ may be defined for each circuit type as shown in Table 1 given below and follow a relation equation shown in Equation 43 given below.

$${d}_{i} = \frac{1 - {b}_{i} {c}_{i}}{{a}_{i}} \qquad ( Equation 43 )$$

Table 1 given below shows the ABCD parameter values for each type of impedance loading circuit.

TABLE 1

| | Type | | | |
|---|---|---|---|---|
| | pi-type | | T-type | |
| | Transmission | Transmission | Transmission | Transmission |
| ABCD | line is present | line is not present | line is present | line is not present |
| aᵢ | −y₃ᵢ − y₁ᵢ (1 − x₂ᵢy₃ᵢ) | 1 − x₂ᵢy₃ᵢ | −y₂ᵢ | 1 − x₁ᵢy₂ᵢ |
| bᵢ | 1 − x₂ᵢy₁ᵢ | x₂ᵢ | 1 − x₃ᵢy₂ᵢ | x₃ᵢ + x₁ᵢ (1 − x₃ᵢy₂ᵢ) |
| cᵢ | 1 − x₂ᵢy₃ᵢ | y₃ᵢ + y₁ᵢ (1 − x₂ᵢy₃ᵢ) | 1 − x₁ᵢy₂ᵢ | y₂ᵢ |
| dᵢ | −x₂ᵢ | 1 − x₂ᵢy₁ᵢ | −x₃ᵢ − x₁ᵢ (1 − x₃ᵢy₂ᵢ) | 1 − x₃ᵢy₂ᵢ |

Pi-type: y₁ᵢ = Z₀Y₁ᵢ, y₃ᵢ = Z₀Y₃ᵢ, x₂ᵢ = X₂ᵢ/Z₀,
T-type: y₂ᵢ = Z₀Y₂ᵢ, x₁ᵢ = X₁ᵢ/Z₀, x₃ᵢ = X₃ᵢ/Z₀

Hereinabove, when the impedance loading circuit has the transmission line and the pi-type structure, the method for calculating the loaded impedance value has been described, but in the other case (the impedance loading circuit has no transmission line or has the T-type structure), the loaded impedance value may be calculated by the same method by using the ABCD parameters defined in Table 1 given above.

Next, the compact antenna unit 240 according to the exemplary embodiment of the present invention will be described.

As illustrated in FIG. 2, the number of antenna elements constituting the compact antenna unit 240 is the same as the number of spatial multiplexing streams. For example, when four spatial multiplexing streams are intended to be transmitted, the compact antenna unit 240 has at least four antenna elements.

A separation distance d of the antenna elements constituting the compact antenna unit 240 may be set to be smaller than a half-wavelength distance. The reason is that the basis beam patterns are derived from the antenna steering vector to which the antenna geometry is reflected for the beam-space MIMO transmission.

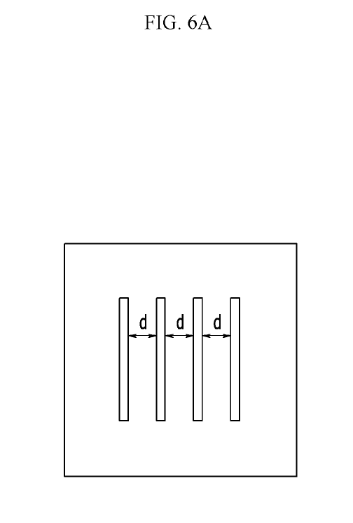

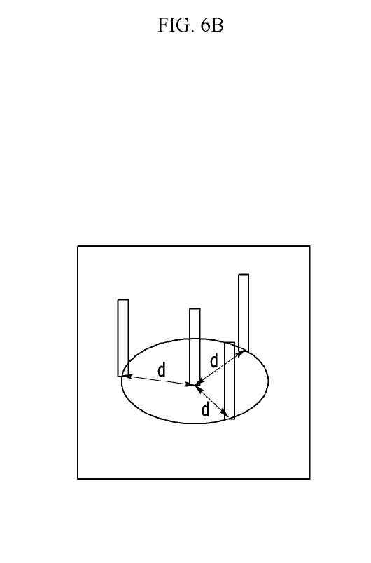

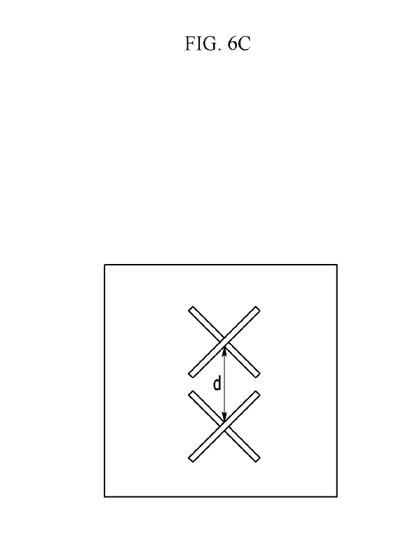

The antenna elements constituting the compact antenna unit 240 may be variously disposed. FIGS. 6A to 6C are diagrams illustrating various layouts of the respective antenna elements. In FIGS. 6A to 6C, four antenna elements are illustrated for easy description.

As illustrated in FIG. 6A, the antenna elements constituting the compact antenna unit 240 may be configured in parallel. As illustrated in FIG. 6B, the antenna elements constituting the compact antenna unit 240 may be disposed circularly around one element. Meanwhile, FIGS. 6A and 6B illustrate a layout using an antenna having a single polarity, and as illustrated in FIG. 6C, an antenna layout using a polarization characteristic may also be available. The separation distance d between the antennas is illustrated in FIGS. 6A to 6C, and as the separation distance d, a value smaller than the half-wavelength separation distance may be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A beam-space MIMO transmission apparatus comprising:
a first impedance loading circuit connected to a first antenna element and including a plurality of first imaginary number impedance elements;
a second impedance loading circuit connected to a second antenna element and including a plurality of second imaginary number impedance elements;
a beam-space multi-input multi-output (MIMO) control unit receiving a spatial multiplexing signal for beam-space MIMO and calculating and setting loading values of the plurality of first and second imaginary number impedance elements in response to the spatial multiplexing signal; and
a radio frequency (RF) chain unit generating a first signal having a predetermined carrier frequency and amplifying the first signal and transmitting the amplified first signal to the first and second impedance loading circuits.

2. The apparatus of claim 1, wherein:
the first impedance loading circuit includes only the plurality of first imaginary number impedance elements, and
the second impedance loading circuit includes only the plurality of second imaginary number impedance elements.

3. The apparatus of claim 1, wherein:
the first impedance loading circuit includes only the plurality of first imaginary number impedance elements and a first transmission line connected to the plurality of first imaginary number impedance elements; and
the second impedance loading circuit includes only the plurality of second imaginary number impedance elements and only a second transmission line connected to the plurality of second imaginary number impedance elements.

4. The apparatus of claim 1, wherein
the beam-space MIMO control unit control unit includes:
a beam-space mapping unit calculating current introduced into the first antenna element and the second antenna element by considering information on the spatial multiplexing signal; and
a load modulator control unit calculating loading values of the plurality of respective antenna elements by using the calculated current.

5. The apparatus of claim 4, wherein
the beam-space mapping unit calculates the current by further considering information on basis beams orthogonal to each other and information on geometrical structures of the first and second antenna elements.

6. The apparatus of claim 1, wherein
the first signal is a sine wave having a fixed size and a fixed phase.

7. The apparatus of claim 6, wherein
the RF chain unit includes:
an oscillator generating the first signal; and
a power amplifier amplifying the first signal.

8. The apparatus of claim 1, wherein
the plurality of first imaginary number impedance elements have a pi-type structure, and
the plurality of second imaginary number impedance elements have the pi-type structure.

9. The apparatus of claim 1, wherein
the plurality of first imaginary number impedance elements have a T-type structure, and
the plurality of second imaginary number impedance elements have the T-type structure.

10. A beam-space multi-input multi-output (MIMO) transmission method generating a beam-space signal by modulating loads connected to a plurality of antenna elements, respectively, the method comprising:
providing a plurality of imaginary number impedance elements to each of the plurality of antenna elements;
generating a spatial multiplexing signal with respect to a plurality of data streams;
calculating loading values of the plurality of imaginary number impedance elements in response to the spatial multiplexing signal;
setting the calculated loading values in the plurality of imaginary number impedance elements; and
generating a first signal having a predetermined carrier frequency and transmitting the generated first signal to the plurality of antenna elements and the plurality of imaginary number impedance elements.

11. The method of claim 10, wherein
the calculating of the loading values includes:
calculating current introduced into the plurality of antenna elements by using the spatial multiplexing signal; and
calculating loading values of the plurality of imaginary number impedance elements by using the calculated current.

12. The method of claim 10, wherein
the first signal is a sine wave having a fixed size and a fixed phase which do not vary according to the spatial multiplexing signal.

13. The method of claim 10, wherein
the load is constituted by only the plurality of imaginary number impedance elements.

14. A beam-space MIMO base station, comprising:
a compact antenna unit including a plurality of antenna elements;
a plurality of impedance loading circuits including a plurality of imaginary number impedance elements connected to the plurality of antenna elements, respectively;
a baseband unit generating a spatial multiplexing signal with respect to a plurality of data streams corresponding to the plurality of antenna elements;
a beam-space MIMO control unit calculating loading values of the plurality of imaginary number impedance elements in response to the spatial multiplexing signal and setting the calculated loading values in a plurality of impedance loading circuits; and
an RF chain unit generating a first signal having a predetermined carrier frequency and transmitting the generated first signal to the plurality of impedance loading circuits.

15. The base station of claim 14, wherein
each of the plurality of impedance loading circuits is constituted by only the plurality of imaginary number impedance elements without a resistance component.

16. The base station of claim 14, wherein
the beam-space MIMO control unit includes:
a beam-space mapping unit calculating current introduced into each of the plurality of antenna elements by considering information on the spatial multiplexing signal, information on basis beams orthogonal to each other, and information on a geometrical structure of the compact antenna unit; and
a load modulator control unit calculating the loading values of the plurality of imaginary number impedance elements by using the calculated current.

17. The base station of claim 14, wherein
the first signal is a sine wave having a fixed size and a fixed phase which do not vary according to the spatial multiplexing signal.

18. The base station of claim 14, wherein
the plurality of imaginary number impedance elements have a pi-type structure or a T-type structure.

19. The base station of claim 14, wherein
the plurality of antenna elements are positioned at a distance that is smaller than a half-wavelength separation distance from each other.
